(19) United States
(12) Patent Application Publication
(10) Pub. No.: US 2011/0091848 A1
(43) Pub. Date: Apr. 21, 2011

(54) Task Minder System

(75) Inventors: Douglas A. Cooksy, Raleigh, NC (US); Bradley B. Cooksy, Lakeville, MN (US)

(73) Assignee: COOKSY DESIGN SOLUTIONS, LLC, Lakeville, MN (US)

(21) Appl. No.: 12/953,517

(22) Filed: Nov. 24, 2010

Related U.S. Application Data
(63) Continuation of application No. 11/683,097, filed on Mar. 7, 2007.
(60) Provisional application No. 60/780,427, filed on Mar. 8, 2006.

(51) Int. Cl. G09B 19/00

(52) U.S. Cl. 434/238

(57) ABSTRACT

In one or more embodiments, a task minder comprises a personal electronic device configured to prompt its user for input at timed intervals. The task minder, which may be a wearable device, allows its user to input a “positive” response indicating that the user is on task, or a “negative” response indicating that the user is off task. Response data collected by the task minder over a number of response intervals indicates the user's success in focusing on assigned tasks, and the repeated prompting for response inputs positively modifies the user's behavior by making him or her more conscious of time and providing positive behavior reinforcement through tracking on-task and off-task performance. The system may further include computer software to collect and analyze task performance data from task minders, and may include a master unit to monitor/control task minders, which may be an appropriately configured PC or a standalone unit.

### RELATED APPLICATIONS

This application is a continuation of and claims priority from the co-pending U.S. application Ser. No. 11/683,097, which was filed Mar. 7, 2007, and from the U.S. provisional patent application identified by App. No. 60/780,427, which was filed 8 Mar. 2006, both of which are incorporated herein by reference in their entirety.

### BACKGROUND

1. Technical Field

The present invention generally relates to behavioral evaluation and training, and particularly relates to task-related behavioral evaluation and training.

2. Background

Not all people possess the same ability to stay focused on an assigned task. Behaviorists recognize that some people in particular have attention deficits that compromise their ability to focus on given tasks. Without the ability to stay focused, such persons often fail to complete assigned tasks in a timely manner, and the quality of their work often suffers.

Attention-related disorders, often broadly referred to as Attention Deficit Disorder/Attention Deficit Hyperactivity Disorder (ADD/ADHD), occupy a position of increasing importance in the behavioral studies. Driving this emphasis is a recognition of the prevalence of attention-related disorders and a growing understanding of how profoundly such problems affect childhood education and adult work performance.

### SUMMARY

In one or more embodiments, a task minder system includes a task minder that comprises a personal electronic device configured to prompt its user for input at timed intervals. More particularly, the task minder, which may be a wearable device, allows its user to input a “positive” response indicating that the user is on task, or a “negative” response indicating that the user is off task. Response data collected by the task minder over a number of response intervals indicates the user's success in focusing on assigned tasks, and the repeated prompting for response inputs positively modifies the user's behavior by making him or her more conscious of time and providing positive behavior reinforcement through tracking on-task and off-task performance.

Complementing the task minder's collection of user response data, generally referred to as task performance data, one or more embodiments of the task minder system include computer software configured to obtain and process task performance data from one or more task minders. For example, a task minder may couple to a personal computer (PC) directly, such as through an RS-232 or USB interface, or indirectly, such as through a Bluetooth or other short-range radio interface. The task minder program uploads task performance data to the PC and analyzes the data or otherwise presents it for analysis.

For example, the task minder program may generate graphs or charts of the task performance data, and track differences between different sets of task performance data, such as data collected on different days, collected for different tasks or types of tasks, etc. Further, one or more embodiments of the task minder program are configured to track and maintain information for different task minder users, allowing a teacher or other supervisor to monitor the performance of several children using different task minders, for example. To that end, uploaded task performance data may be manually identified by user input to the task minder program, or may be automatically identified, such as by individual task minder units having different electronic identification numbers.

While one or more embodiments of the task minder program provide sophisticated task performance data analysis, and longer-term tracking of task performance data, the task minders themselves are, in one or more embodiments, configured to provide performance feedback. For example, in one embodiment, the task minder provides a performance indication that identifies generally or specifically how well the user has done in terms of staying on-task. In one embodiment, the task minder blinks one light to indicate the off-task response count and blinks another light to indicate the on-task response count. The task minder can use different beeps or tones to convey similar information to the user regarding off-task and on-task response counts.

In another embodiment, the task minder includes a bar graph or other visual indicator that it uses to indicate the relative off-task and on-task response counts. In another embodiment, the task minder compares accumulated on-task and off-task response counts and illuminates one light if the on-task count is greater, another light if the off-task count is greater, and, optionally, a third light if they are equal. Of course, the task minder's illumination logic can be modified to vary illumination intensity, etc., to reflect performance. In other embodiments, the task minder includes a display, such as an inexpensive LCD. In such embodiments, the task minder can be configured to display various icons related to on-task and off-task response counts, operating modes, battery life, etc.

In terms of operating modes, one embodiment of the task minder provides a selectable set of prompt intervals, e.g., 5 minute, 10 minute, 20 minute, and 30-minute intervals. The interval can be selected via one or more external switches positioned in or on the task minder's housing. In another embodiment, accessible dip switches provide for prompt interval configuration. In another embodiment, the user interface of the task minder allows its user to program various aspects of the task minder, including the prompt interval. Of course, however its operational aspects are configured, the task minder may restrict how its operational parameters are configured, so that only an authorized person—e.g., teacher, clinician or doctor—can change the task minder's operating configuration.

The task minder also may use a random prompt interval, which may be advantageous for some users. Further, in at least one embodiment, the task minder adaptively changes its prompt interval as a function of its user's performance. For example, if the prompt responses input to the task minder by the user indicate that the user is more often off-task than on-task, the task minder may decrease the prompt interval. Conversely, if the user reports that he or she is more often (or always) on-task, the task minder may adaptively lengthen its prompt interval. Such adaptation may use fixed intervals, random intervals, or a mix of fixed and random intervals, and the task minder may be configured occasionally to deviate from its current prompt interval timing by using a substantially shortened or lengthened interval.

As a further point of flexibility, the task minder may be configured to prompt for response input using different vibrations, e.g., strong and weak vibrations, and such variations may be adaptively used as a function of current or past performance. The task minder also can be configured to use a visual indicator, such as a blinking light. Such operation may yield benefits for at least some users, by giving the user increased responsibility in terms of anticipating prompt times and looking for the blinking indicator. Vibratory and blinking prompts may be intermixed, such as vibration if the user is performing poorly and blinking lights if the user is performing well.

As a further point of flexibility, the task minder may be configured to communicate with a supervisory and/or monitoring system, which may be implemented as a dedicated master unit or implemented via a PC with appropriate software and interfacing, thus allowing the PC to function as the master unit. Thus, in one embodiment, task performance data, either previously collected or real-time, can be transmitted from individual task minders to a centralized system, such as by radiofrequency signaling. Task minders also may include the ability to communicate with each other. Further, in one embodiment, the task minder system includes a “master timer” that is configured to monitor multiple task minders, such that a user of the master timer can monitor and/or control individual task minders. Examples of such control include sending manual prompts to targeted task minders, changing the type or strength of the prompt, varying the prompt interval, etc. In at least one embodiment, the centralized system can be used to retrieve and/or reset task performance data from targeted task minders.

With the above embodiment(s) in mind, the task minder operates as a self-regulatory instrument offering particular advantages to individuals with behavioral symptoms generally described as attention deficit disorders, with or without attendant hyperactivity disorders. By collecting on-task and off-task response inputs over time, the task minder provides a performance history indicating its user's ability to stay focused. Notably, that performance history represents the user's self-evaluation, i.e., the user's response to the task minder's prompts, which reflect the user's assessment of whether the user is on-task or off-task.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of one embodiment of a task minder.

FIG. 2 is a block diagram of one embodiment of a task minder system, including one or more task minders and a corresponding task minder computer program.

FIG. 3 is a block diagram of one embodiment of a computer configured to support a task minder system.

FIG. 4 is a block diagram of one embodiment of a task minder master unit.

FIG. 5 is a logic flow diagram of a method of positive behavior modification based on self-evaluation, as taught herein.

### DETAILED DESCRIPTION

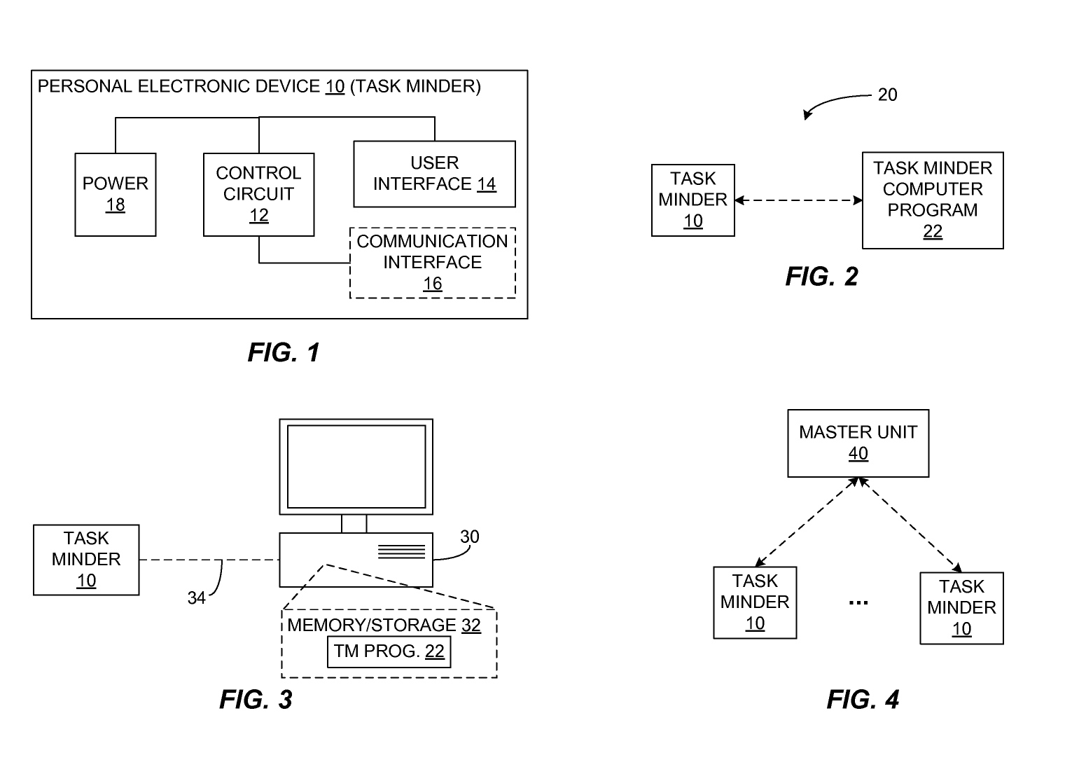

FIG. 1 illustrates one embodiment of a personal electronic device 10 (hereinafter referred to as “task minder 10”), housing a control circuit 12, a user interface 14, an optional communication interface 16, and a power source 18. In at least one embodiment, the task minder 10 is configured as a wearable electronic device, such as a watch-like device, a pager device which may be clipped to a belt or clothing, etc. Regardless, in operation, the task minder 10 positively modifies a task focus behavior of a person.

More particularly, one or more embodiments of the control circuit 14 are configured to prompt the person at timed intervals to provide an input response, each input response being one of a positive response or a negative response based on the person's self evaluation of whether the person currently is on task or off task. The control circuit 14 is further configured to collect the input responses over time as task performance data and provide an indication of task performance to the person based on the task performance data. For example, the control circuit 14 may accumulate positive and negative response inputs in a memory (volatile or non-volatile) and provide an indication of the task performance from those accumulated responses, when prompted to do so by the person (or by a supervisory user).

In one or more embodiments, the user interface has one or more input elements enabling the person to enter input responses, and has one or more output elements for prompting the person to enter input responses. With this configuration, the control circuit 12 may be operatively associated with the user interface 14 and configured to thereby prompt the person at timed intervals to enter input responses, collect the input responses as task performance data, and output an indication of task performance to the person based on evaluating the task performance data.

Notably, as will be detailed later herein, one or more embodiments of the control circuit 12 are configurable to operate in one or more default modes relating to one or both of a timing behavior of the control circuit 12 relating to its timing of the timed intervals and a prompting behavior of the control circuit 12 relating to its prompting for response inputs. The ability to set the default timing and/or prompting behaviors of the control circuit 12 allows a supervisory user to tailor operation of the task minder 10 to a severity or nature of task focus problems exhibited by the person who will be using the task minder 10.

Broadly stated, it will be understood that in general operation, at least one embodiment of the control circuit 12 periodically prompts a user of the task minder 10 to input a response indicating whether the user is on task or off task. Further, some embodiments of the task minder 10 support modes of operation wherein the task minder 10 uses random timing intervals, and uses unprompted operation and/or modified prompting, e.g., visual versus vibratory.

The control circuit 14 may comprise a general or special-purpose microprocessor or other type of processing circuit, such as a Complex Programmable Logic Device (CPLD). In particular, in one embodiment, the control circuit 14 comprises a low-cost microcontroller that incorporates hardware- and/or software-based timer/counters for determining the timed intervals used for prompting. Regardless of the timer configuration, the control circuit 14 uses timer expiration to trigger prompting via the user interface 12. For example, the user interface 12 may include an electromechanical vibrator activated in response to timer expiration. Further, the user interface 12 includes one or more input controls that permit the user to input on-task and off-task responses, such that the task minder 10 can accumulate the user responses recorded for a series of prompts and thereby provide a basis for evaluating the user's ability to focus.

In general, it should be understood that the task minder 10 can be programmed or otherwise configured for a number of operating behaviors, and that certain ones of these behaviors (style of timing and/or prompting) can be set by default, and, in one or more embodiments, can be altered or intermixed by the task minder 10 on the fly, based on evaluating the task performance data, for example. That is, in one or more embodiments, the control circuit 12 is configurable in response to (supervisory) user input to set or select one or more modes of operation relating to at least one of its timing behavior for timing the timed intervals and its prompting behavior for prompting the person at the timed intervals to provide an input response. As a non-limiting example, the timing behavior of the control circuit 12 is selectable as periodic or random, or variable, and the prompting behavior of the control circuit 12 is selectable as visual, vibratory, or variable. “Variable” in this sense connotes a mixed behavior.

Further, in at least one embodiment, the control circuit 12 is configured to dynamically adapt its manner of prompting the person based on evaluating the task performance data. This adaptation allows the task minder 10 to change its prompting behavior to better suit the ability or inability of the person to stay on task. For example, the control circuit 12 is configured in one or more embodiments to dynamically adapt its manner of prompting the person based on evaluating the task performance data by using a visual prompt if the task performance data indicates favorable on task performance, and using a vibratory prompt if the task performance data indicates unfavorable on task performance. The vibratory prompt may be considered as more aggressive or obtrusive prompting, and thus is desirable at least on a temporary basis if the task performance data indicates unfavorable on task performance.

In the same or other embodiments of the task minder 10, the control circuit 12 is configured to dynamically adapt its manner of prompting the person based on evaluating the task performance data by using a lower prompt intensity or duration if the task performance data indicates favorable on task performance, and using a higher prompt intensity or duration if the task performance data indicates unfavorable on task performance. Again, this operation represents a non-limiting approach for less aggressively or more aggressively prompting the person in dependence on the person's on task performance.

Notably, the task minder 10 may be configured that all such behaviors adapt in real-time or according to a desired adaptation rate or schedule, as input responses are accumulated and on task performance is evaluated on an ongoing basis. In this context, the control circuit 12 may be configured to determine whether the task performance data indicates favorable or unfavorable on task performance by comparing positive and negative response counts represented in the task performance data.

Similarly, in one or more embodiments of the task minder 10, the control circuit 12 is configured to dynamically adapt its timing used for prompting the person at timed intervals based on evaluating the task performance data. For example, in one such embodiment, the control circuit 12 is configured to dynamically adapt its timing used for prompting the person at timed intervals based on evaluating the task performance data by increasing a duration of the timed intervals if the task performance data indicates favorable on task performance and decreasing a duration of the timed intervals if the task performance data indicates unfavorable on task performance. In the same or other embodiments, the control circuit 12 is configured to dynamically adapt its timing used for prompting the person at timed intervals based on evaluating the task performance data by using periodic interval timing if the task performance data indicates favorable on task performance and using random interval timing if the task performance data indicates unfavorable on task performance.

Whether or not the above methods of dynamic timer adaptation are used, in at least one embodiment of the control circuit 12, it is configured to intermittently use shortened or otherwise altered timed interval durations for prompting the person, to thereby provide prompts to the person at unexpected times. Such behavior is useful, for example, where it is desirable to challenge the person with more than periodically timed intervals, or where it is desirable to assess whether the person exhibits good on task performance in the face of significantly changed prompting intervals.

As a further method of improving the behavioral modification efficacy of the task minder 10 through dynamically adapted operational behaviors, at least one embodiment of the control circuit 12 is configured to initially prompt upon expiration of any given timed interval according to a first style or intensity of prompting, and to provide further prompting if the person fails to respond to the initial prompt according to a changed style or intensity of prompting. For example, the control circuit 12 may use increasingly long or intense activations of a visible indicator or a vibratory prompt if the person delays entry of the input response, or may switch from visible to vibratory prompting, or may switch from visible (or vibratory) prompting to a combination of both.

In discussing prompting styles or behaviors, it will be understood that one or more embodiments of the user interface 14 include one or more visible indicators, wherein the control circuit 12 is configured to provide the indication of task performance based on controlling one or more of the one or more visible indicators. For example, in one embodiment, the user interface 14 includes first and second visible indicators, and the control circuit 12 provides the indication of task performance by actuating the first and second visible indicators, respectively, according to negative and positive response counts determined from the task performance data.

In another embodiment, the user interface 14 includes a visible indicator having a variable indication characteristic. In such embodiments, the control circuit 12 provides the indication of task performance by varying the variable indication characteristic of the visible indicator as a function of the task performance data. The variable characteristic may be the number of segments illuminated in a bar graph, for example, or the intensity, blink rate, etc. of a visible indicator.

In a more specific, but non-limiting example of the task minder 10, the user interface 14 may include a number of switches, e.g., dip switches, allowing a user to select the time interval(s) and/or timing style (periodic, random). For example, the task minder 10 may offer a number of predefined timing intervals, each having a corresponding dip switch setting, such that the user positions the dip switches according to the desired timing interval. While such switches may be considered part of the user interface 14, it will be understood that such switches may require removal of a cover, and their usage may be restricted to supervisory users.

In any case, visible indictors available in one or more embodiments of the user interface 14, e.g., LEDs, may be used to facilitate timing interval selection. For example, a number of visible indicators may be illuminated in a selective pattern corresponding to the configuration of the timing interval switch settings, thus providing the user with visual feedback regarding the currently selected timing interval.

With its time interval thus configured, the task minder 10 in operation will provide prompts to its user at the timed intervals. For example, the task minder 10 may vibrate for approximately ten (10) seconds upon expiration of each interval. This vibration prompts the user to press one of two buttons, where one button represents a positive response (on task) and the other button represents a negative response (off task). Of course, one or more embodiments of the task minder 10 may user other positive/negative response input mechanisms, such as a rocker switch, or may provide a display screen based interface, with physical or virtual buttons.

The control circuit 12 detects or otherwise recognizes which type of input response (positive or negative) was received, and stores corresponding information in its memory. For example, the task minder 10 may accumulate positive and negative responses in running accumulators (count totals), such that how well the user of the task minder 10 is doing with regard to task focusing can be discerned from a comparison of the positive and negative response counts. In any case, after or along with updating its stored information, the control circuit 12 resets its timing mechanism—software or hardware counter—and begins timing the next interval.

To provide indications of task performance to the person using the task minder 10, and to others interested in that person's behavior, one or more embodiments of the task minder 10 provide a “results” button which, when pressed, uses one or more visible indicators in the user interface 14 to indicate positive and negative response counts (i.e., indicate total counts for the times the user's self evaluation was that the user was on task and off task). For example, the task minder 10 may use one LED to flash positive response totals and another LED to flash negative response totals. The task minder 10 may automatically reset its accumulated accounts, at least for purposes of local display (although it may retain data for computer uploading), such that the person using the task minder 10 can start over on a new set of tasks. Alternatively, the task minder 10 does not automatically clear its current task performance data until explicitly commanded to do so, such as by pressing a sequence of buttons and/or pressing/holding one or more designated buttons.

Turning from aspects of an individual task minder 10, this disclosure further contemplates a task performance monitoring system comprising the task minder 10, and further comprising computer readable media storing a computer program operative to retrieve task performance data from the task minder 10, analyze the retrieved task performance data, and output corresponding analysis results. For example, FIG. 2 illustrates a task minder system 20, which includes one or more task minders 10 to provide collected task performance data for presentation and/or analysis by a task minder computer program 22.

In one embodiment, the task minder computer program 22 comprises a computer program product including computer code for uploading task performance data from task minders 10, and analyzing or presenting such data for analysis. By way of non-limiting example, the task minder computer program 22 may be configured for execution on WINDOWS-based computer systems and/or on MACINTOSH-based computer systems.

Regardless of operating system compatibility details, FIG. 3 illustrates that a computer 30 may store executable computer code for the task minder computer program 22 in one or more memory/storage devices 32. As such, the task minder computer program 22 may upload task performance data from a task minder 10 that is communicatively coupled to the computer 30 through a communication link 34. To support such communications, the optional communication interface 16 of the task minder 10 may include, for example, a USB interface. Alternatively, or additionally, the communication interface 16 may include a short-range radiofrequency circuit, such as a Bluetooth or IEEE 802.11b transceiver circuit.

In addition to uploading task performance data via the communication link 34, the task minder program 22 also may use the link to download configuration or other data to the task minder 10. By way of non-limiting example, configuration data may include one or more of a default prompting interval to use, default prompt type, etc. In at least one embodiment, the prompting behavior and timing behavior of a given task minder 10 can be tailored using the task minder program 22. Personalization data also may be downloaded, such as user name or other identification data.

With the above system 20 in mind, and as a non-limiting example, a commercial “package” for the task minder system 20 generally will include at least one task minder 10, supporting connection cables, e.g., USB cables, and the computer software 22. A given task minder 10 is assigned to a given person, e.g., a child with ADD or some other disorder that impairs the child's ability to focus on tasks. The person wears the task minder 10, or otherwise keeps it on his or her person, and uses the task minder 10 to perform self evaluations of whether he or she is on or off task during the performance of one or more given tasks.

For example, the task minder 10 may be set to use a vibratory prompt, and the user interface 14 may provide a green button for inputting positive responses (on task) and may provide a red button for inputting negative responses (off task), at each vibratory prompt. In this manner, the task minder 10 accumulates positive and negative responses as task performance data, wherein the person's overall task performance is indicated, for example, by the ratio of positive response counts to negative response counts.

Thus, a teacher or other supervisory user may choose to upload task performance data from one or more task minders 10 at the end of a school day, or at the end of a designated series of tasks. The analysis of the task performance data as provided by the task minder program 22 can be used to adjust existing behavioral modification plans associated with the users of the task minders 10.

According to at least one embodiment of the above task minder program 22, the computer 30 is configured via software (and any necessary communication interfaces) to function as a master unit for remotely monitoring and controlling individual task minders 10, or groups of task minders 10. Functionally, such a master unit comprises one or more control circuits configured to monitor the operation of individual task minders 10, or groups of task minders 10, and selectively controls operation of task minders in response to user input at the master unit. For example, the master unit may be configured to monitor the operation of one or more task minders 10 based at least in part on receiving task performance data from them. As another example, the contemplated master unit may be configured to selectively change one or more prompting behaviors of selected task minders 10 or groups of task minders 10, responsive to user input at the master unit. Such input may be restricted via password or other supervisory access controls.

In at least one embodiment, the master unit monitors task performance data from one or more task minders, and analyzes that data as a basis for dynamically varying operation of the monitored task minders 10. For example, the master unit may recognize from uploaded task performance data that the person using a given one of the monitored task minders 10 is doing poorly, as indicated by the proportion of negative responses, or as indicated by the number of prompt response failures. In any case, the master unit may signal the corresponding task minder 10 to change its prompting interval and/or to change its prompting style. For example, the task minder 10 may switch from a visual prompt to a vibratory prompt, or may switch from using a non-blinking visible prompt to a blinking visible prompt, or may shorten the durations of its timed intervals, or switch to random interval timing.

In any case, the contemplated master unit, whether implemented via the computer 30, or as a dedicated electronic device or unit, generally can communicate with one or more task minders 10 for monitoring and control. In one or more embodiments the master unit and the task minder 10 include complementary wireless communication interfaces, such that the master unit communicates with the task minder 10 via a wireless communication link. For example, referring to FIG. 4, one sees one embodiment of a master unit 40, wherein the communication interfaces 16 of the illustrated task minders 10 provide bidirectional or unidirectional communications with the master unit 40.

In at least one embodiment, the master unit 40 communicates with a plurality of task minders 10, thereby allowing its operator, such as a teacher or doctor, to monitor and/or control individual task minders 10. For example, the master unit 40 may receive task performance data from individual task minders 10, and may provide indications of each task minder user's current performance. Additionally, or alternatively, the master unit 40 sends control and/or configuration data to individual task minders 10. For example, the master unit 40 may be used to initiate user prompting at individual ones of the task minders 10. In one or more embodiments, the master unit 40 also may be used to change prompt types, prompting intervals, etc. In other embodiments, the master unit 40 asynchronously or synchronously tracks the timing intervals of the individual task minders 10, so that its operator knows when (and if) the individual users of the task minders 10 are, or should be, paying attention to the prompts.

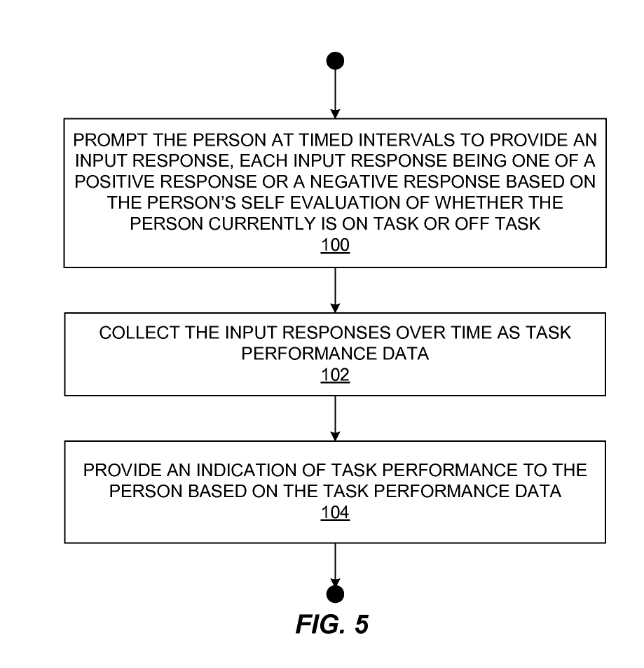

Of course, whether or not a master unit 40 is used, the task minder 10 by itself represents an advantageous mechanism for positively modifying the task focus behavior of a person. Broadly, this disclosure teaches a method for positively modifying a task focus behavior of a person. As shown in FIG. 5, in one or more embodiments, that method includes prompting a person at timed intervals to provide an input response (Step 100), where each input response is either a positive response or a negative response as determined by the person's self evaluation of whether the person currently is on task or off task. That is, the person entering the response is responsible for determining through self evaluation whether the person is, at that moment, on task or off task. The method further includes collecting the input responses over time as task performance data (Step 102), and providing an indication of task performance to the person based on the task performance data (Step 104).

As non-limiting examples, these method steps may be carried out through the execution of computer program instructions, such as where the task minder 10 includes a general or special purpose microprocessor and stored program instructions. Alternatively, the method steps can be carried out through the operation of appropriately configured digital logic, which may be implemented discretely, but is advantageously implemented using an integrated logic device, such as an FPGA or CPLD.

Regardless of the processing implementation used to practice the method, in at least one embodiment, the method further includes dynamically adapting a manner of prompting the person at the timed intervals based on evaluating the task performance data. For example, the method may include varying a type or intensity of prompt depending on whether the task performance data indicates favorable or unfavorable on task performance. As another example, the method may include using a visual prompt if the task performance data indicates favorable on task performance, and using a vibratory prompt if the task performance data indicates unfavorable on task performance. As another example, the method may include using a lower prompt intensity or duration if the task performance data indicates favorable on task performance, and using a higher prompt intensity or duration if the task performance data indicates unfavorable on task performance. (As noted, determining whether the task performance data indicates favorable or unfavorable on task performance by comparing positive and negative response counts represented in the task performance data.)

As a further aspect of dynamic variation, the method may include dynamically adapting a timing behavior used for prompting the person at the timed intervals based on evaluating the task performance data. For example, the method may include increasing a duration of the timed intervals if the task performance data indicates favorable on task performance and decreasing a duration of the timed intervals if the task performance data indicates unfavorable on task performance. As another example, the method may include using periodic interval timing if the task performance data indicates favorable on task performance and using random interval timing if the task performance data indicates unfavorable on task performance.

Along the same lines, but independent of whether dynamic adaptation of period versus random timing is used, the method may include intermittently using shortened or otherwise altered timed interval durations for prompting the person, to thereby provide prompts to the person at unexpected times. Thus, where a given task minder 10 generally is configured, for example, to use a regularly timed prompting interval of, say 5 minutes, it may still, nonetheless use a significantly abbreviated timing interval, say 2 minutes, from time to time.

Of course, whether such variations are used in timing the prompting intervals, the method may include dynamic adaptation of the prompt itself. For example, if the person is doing well (as indicated by the task performance data), the prompting style may be less aggressive or obtrusive, e.g., a solid light. If the person is doing less well, the prompting may be more aggressive or obtrusive, e.g., a blinking light or a vibratory prompt. Also, whether such general variations in prompting style are used, the method may include initially prompting the person upon expiration of any given timed interval according to a first style or intensity of prompting, and further prompting if the person fails to respond to the initial prompt according to a changed style or intensity of prompting.

With the method variations in mind, and with the many illustrations and examples given for the task minder 10, the task minder system 20, and the master unit 40, those skilled in the art will appreciate that the present invention is not limited by the foregoing discussion nor by the accompanying figures. Indeed, the present invention is limited only by the following claims and their legal equivalents.

What is claimed is:

1. A task performance monitoring system comprising:
a plurality of task minders, each task minder associated with a different task minder user and comprising:
a communication interface for transmitting a set of task performance data from the task minder device, wherein the set of task performance data includes information identifying the task minder;
a user interface configured for prompting the task minder user and correspondingly receiving input responses from the task minder user;
a control circuit operatively associated with the user interface and configured to generate the set of task performance data by prompting the task minder user at timed instances and, for each prompt, recording whether the task minder user inputs a positive response to the prompt indicating that the user is on task or a negative response to the prompt indicating that the user is not on task; and
a computer including or otherwise associated with a communication interface for receiving the sets of task performance data from the plurality of task minders, said computer comprising a processing unit that is configured to maintain task performance information for one or more of the task minder users by identifying the sets of task performance data received from the task minders corresponding to those one or more task minder users and storing the identified sets of task performance data or analysis data obtained from said processing unit analyzing the identified sets of task performance data.

2. The task performance monitoring system of claim 1, wherein the computer includes or is associated with an output device, and wherein the processing unit is configured to generate charting data for outputting to the output device, according to the task performance information tracked and maintained by the computer for one or more of the task minder users.

3. The task performance monitoring system of claim 1, wherein the processing unit is configured to analyze the identified sets of task performance data by determining the differences between different ones of the sets of task minder performance data and to store data indicating the determined differences as said task performance information.

4. The task performance monitoring system of claim 3, wherein said task performance information indicates differences between the positive and negative responses recorded in two or more of the identified sets of task performance data.

5. The task performance monitoring system of claim 1, wherein the processing unit is configured to dynamically adapt a prompting behavior of one or more of the task minders, based on evaluating the task performance data corresponding to the one or more task minders.

6. The task performance monitoring system of claim 5, wherein the processing unit is configured to dynamically adapt the prompting behavior of a given task minder by changing at least one of a prompt timing and a manner of prompting, and wherein any given task minder has at least two manners of prompting, including two or more of: a visual manner of prompting, an audible manner of prompting, and a vibratory manner of prompting.

7. The task performance monitoring system of claim 5, wherein the processing unit is configured to dynamically adapt the prompting behavior of a given task minder by configuring the given task minder to use a visual prompt, if analysis of the corresponding task performance data indicates favorable on-task performance by the task minder user, and by configuring the given task minder to use a vibratory prompt, if analysis of the corresponding task performance data indicates unfavorable on-task performance by the task minder user.

8. A task performance monitoring system comprising:
a plurality of task minders, each task minder associated with a different task minder user and comprising:
a user interface configured for outputting prompts to the task minder user according to a configured prompting behavior and receiving an input response from the task minder user for each such prompt, wherein the user interface allows the task minder user to enter the input response as a positive response indicating that the task minder user is on task or as a negative response indicating that the task minder user is off task; and
a control circuit configured for controlling the prompting behavior of the task minder according to a defined prompting configuration, and further configured for generating task performance data based on accumulating said input responses; and
a communication interface for receiving prompting configuration information, to define the prompting configuration used by the control circuit for controlling the prompting behavior of the task minder; and
wherein the master unit is included as part of the task performance monitoring system and comprises:
a user interface configured for receiving user inputs from a user of the master unit, for adjusting the prompting behavior of selected ones of the task minders;
a control circuit to select one or more of the task minders, as said selected ones, based on the user input, and to set or update the prompting configuration of the selected ones of the task minder, further based on the user input; and
a communication interface operatively associated with the control circuit and configured to send the prompting configuration to the selected ones of the task minders, to thereby update the prompting behavior of the selected ones of the task minders in accordance with the user input received through the user interface of the master unit.

9. The task performance monitoring system of claim 8, wherein each task minder is configured to send the task performance data to the master unit, and wherein the master unit is configured to display an indication of the on-task performance of any given task minder user, based on the task performance data received from the task minder of that given task minder user.

10. The task performance monitoring system of claim 9, wherein each task minder is configured to include identifying information in the task performance data, and wherein the master unit is configured to identify which task performance data corresponds to which task minder, based on the identifying information included in the task performance data received at the master unit.

11. The task performance monitoring system of claim 8, wherein each task minder has at least two manners of prompting, including two or more of: a visual manner of prompting, an audible manner of prompting, and a vibratory manner of prompting; and wherein the master unit is configured to allow the user of the master unit to set, via the user inputs used to generate the prompting configuration information, the manner of prompting used by the task minder and the timing of said prompting by the task minder.

12. The task performance monitoring system of claim 8, wherein the master unit is configured to send signaling to a given task minder to dynamically vary the prompting behavior of the given task minder, in dependence on the master unit determining from the task performance data received from the given task minder how well or poorly the corresponding task minder user is staying on task.
